(19) United States
(12) Patent Application Publication
(10) Pub. No.: US 2007/0241045 A1
(43) Pub. Date: Oct. 18, 2007

(54) Replaceable tandem filter cartridge assembly

(76) Inventors: Leonard B. Kott, North Massapequa, NY (US); Samuel Miller, Trumbull, CT (US)

Correspondence Address: BODNER & O'ROURKE, LLP, 425 BROADHOLLOW ROAD, SUITE 108, MELVILLE, NY, 11747, US

(21) Appl. No.: 11/405,264

(22) Filed: Apr. 17, 2006

(51) Int. Cl. B01D 29/00

(52) U.S. Cl. 210/338; 210/450; 210/501; 210/502.1

(57) ABSTRACT

A two-stage, tandem, replaceable filter cartridge assembly includes an outer filter cartridge having a cylindrical shape and defining an axial bore therein, and an inner filter cartridge, also having a cylindrical shape which is received within the axial bore of the outer filter cartridge. The inner filter cartridge may be collapsible so that it can be easily inserted inside the axial bore of the outer filter cartridge, and is expandable so that in normal applications, it rests up against the inner surface of the outer filter cartridge's core, if such is included, or filter medium. One or both of the filter media of the inner and outer cartridges may be formed from an antimicrobial material. In a second embodiment, each of the inner and outer filter cartridges has top and bottom end caps which respectively are structured to mate with one another to form seals therebetween to prevent or minimize the egress of water between the mating top and bottom end caps.

### BACKGROUND OF THE INVENTION

1. Field of the Invention

The present invention relates generally to filtering apparatus, and more specifically relates to a replacement filter cartridge assembly for use in aquatic environments such as pools, whirlpool-type tubs and the like.

2. Description of the Prior Art

Replaceable filter cartridge assemblies are used in filter units for filtering water in pools, whirlpool-type tubs and the like to remove impurities therefrom. An example of a replacement filter cartridge assembly is shown in U.S. Pat. No. 5,211,846, which issued to Leonard B. Kott, et al., the disclosure of which is incorporated herein by reference. The filter cartridge, such as the one disclosed in the aforementioned Kott, et al. patent, incorporates a pleated filter medium sandwiched between two axially disposed end caps, with a supporting core assembly situated between the end caps and within the filter medium. The pleated filter medium may be a material such as spun bonded 100% polyester. In many instances, dirty water flows radially through the filter medium, and the filtered clean water moves downwardly exiting the filter housing in which the replacement filter cartridge assembly is situated and returning to the pool or other aquatic environment. Substantial lateral and longitudinal pressures are created on the filter cartridge element by the flow of dirty water through the filter medium and water suction when the filter unit is operated.

Antimicrobial filters have now been used in filtering apparatus for pools and other aquatic environments either to remove bacteria from the water or to minimize the build up of bacteria within the filter unit and bacteria on the filter medium. Such antimicrobial filters are more expensive than untreated filter mediums which are used to filter out impurities and dirt and, as such, their required periodic replacement increases the operating costs of the pool, whirlpool-type tub and the like for the owner or operator.

### OBJECTS AND SUMMARY OF THE INVENTION

It is an object of the present invention to provide a replaceable tandem filter cartridge assembly for use in filtering applications for aquatic environments.

It is another object of the present invention to provide a collapsible antimicrobial filter cartridge that can be easily inserted into a standard cylindrical central bore of a pool or spa filter cartridge.

It is still another object of the present invention to provide a tandem arrangement of inner and outer filter cartridge elements which cooperate to minimize any water leakage between the end caps of each filter element.

It is a further object of the present invention to provide a replaceable tandem arrangement of mating cartridge elements, where each cartridge element may be separately replaced.

In accordance with one form of the present invention, a collapsible antimicrobial filter cartridge is inserted inside the standard cylindrical central bore of either a pool or spa filter cartridge and is expandable so that in normal applications, it rests up against the inner surface of the main filter cartridge's core or filter medium, thus forming with the main filter cartridge a replaceable, two-stage, tandem filter cartridge assembly.

In another form of the present invention, a two-stage, tandem filter cartridge assembly includes an inner filter cartridge and an outer filter cartridge removably mounted on the inner filter cartridge and in radial alignment therewith. Each of the inner and outer filter cartridges includes a pleated filter medium and axial end caps, with a filter medium situated between the end caps. The inner filter cartridge may further include a central core, having openings to allow water to pass through the thickness thereof, the central core being affixed to one or both of the end caps of the inner filter cartridge.

In the second embodiment, the bottom end cap of the inner filter cartridge includes a flange extending radially from the outer periphery thereof, and the bottom end cap of the outer filter cartridge includes a recessed portion formed about the inner periphery thereof to define a seat for at least partially receiving the flange of the bottom end cap of the inner filter cartridge and to form a substantially water tight seal therewith to prevent the egress of water, under pressure, between the two filter cartridges when the two cartridges are mated together.

Preferably, the top end cap of the outer filter cartridge includes a flange radially inwardly extending from the inner periphery of the top end cap, which flange engages the peripheral edge of the top surface of the top end cap of the inner filter cartridge when the two cartridges are mated together, again, to minimize or prevent the passage of water, under pressure, between the two filter cartridges at the top end caps thereof when the two cartridges are mated together.

In this second embodiment of the present invention, the outer filter cartridge has a filter medium formed from antimicrobial material, and even more preferably, the end caps of the outer filter are also formed to contain antimicrobial properties, while the inner filter cartridge is formed as spun bonded 100% polyester to remove dirt and other impurities from the water. Alternatively, both the inner and outer filter cartridges may be formed to have antimicrobial properties, for example, one filter cartridge being formed from an ionic exchange resin and the other filter cartridge being formed from a material having zone inhibiting properties. As a further alternative, both the inner and outer cartridge may have their filter media formed without antimicrobial properties and with the same or different micron retention rates to act as a two-stage filter to remove dirt and other impurities from the water.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is an exploded, perspective view of a replaceable, two-stage, tandem filter cartridge assembly having a collapsible antimicrobial filter cartridge insert formed in accordance with the present invention.

FIG. 2 is a perspective view of the two-stage, tandem filter cartridge assembly of the present invention shown in FIG. 1 in its assembled state.

FIG. 3 is a cross-sectional view of the cartridge assembly shown in FIG. 2, taken along line 3-3 of FIG. 2.

FIG. 4 is an exploded perspective view of another form of a replaceable, two-stage, tandem filter cartridge assembly of the present invention, including the collapsible antimicrobial filter cartridge insert of the present invention.

FIG. 5 is a perspective view of the two-stage, tandem filter cartridge assembly of the present invention shown in FIG. 4 in its assembled state.

FIG. 6 is a cross-sectional view of the cartridge assembly shown in FIG. 5, taken along line 6-6 of FIG. 5.

FIG. 7 is a perspective view of the collapsible antimicrobial filter cartridge insert formed in accordance with the present invention.

FIG. 8 is an exploded perspective view of an alternative form of a replaceable, two-stage, tandem filter cartridge assembly formed in accordance with the present invention.

FIG. 9 is a perspective view of the filter cartridge assembly of the present invention shown in FIG. 8 in its assembled state.

FIG. 10 is an exploded, cross-sectional view of the filter cartridge assembly of the present invention shown in FIG. 8, but shown without pleat bands on the inner filter cartridge.

FIG. 11 is a cross-sectional view of the inner filter cartridge of the two-stage, tandem filter cartridge assembly of the present invention shown in FIGS. 8-10, but shown without pleat bands.

FIG. 12 is a cross-sectional view of the outer filter cartridge of the two-stage, tandem filter cartridge assembly of the present invention shown in FIGS. 8-11.

FIG. 13 is a cross-sectional view of the two-stage, tandem filter cartridge assembly of the present invention shown in FIG. 9, taken along line 13-13 of FIG. 9, but shown without pleat bands on the inner filter cartridge.

### DETAILED DESCRIPTION OF THE PREFERRED EMBODIMENTS

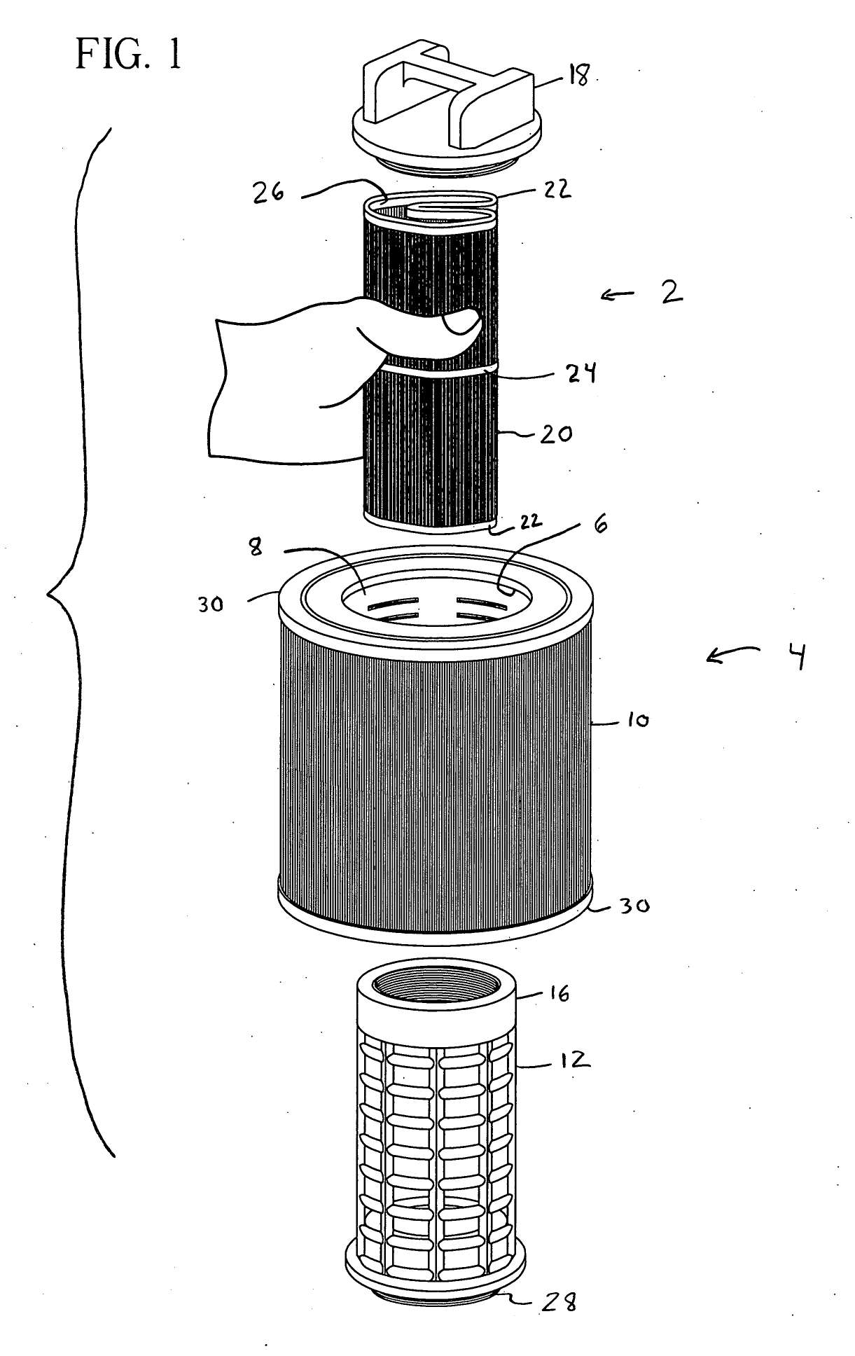

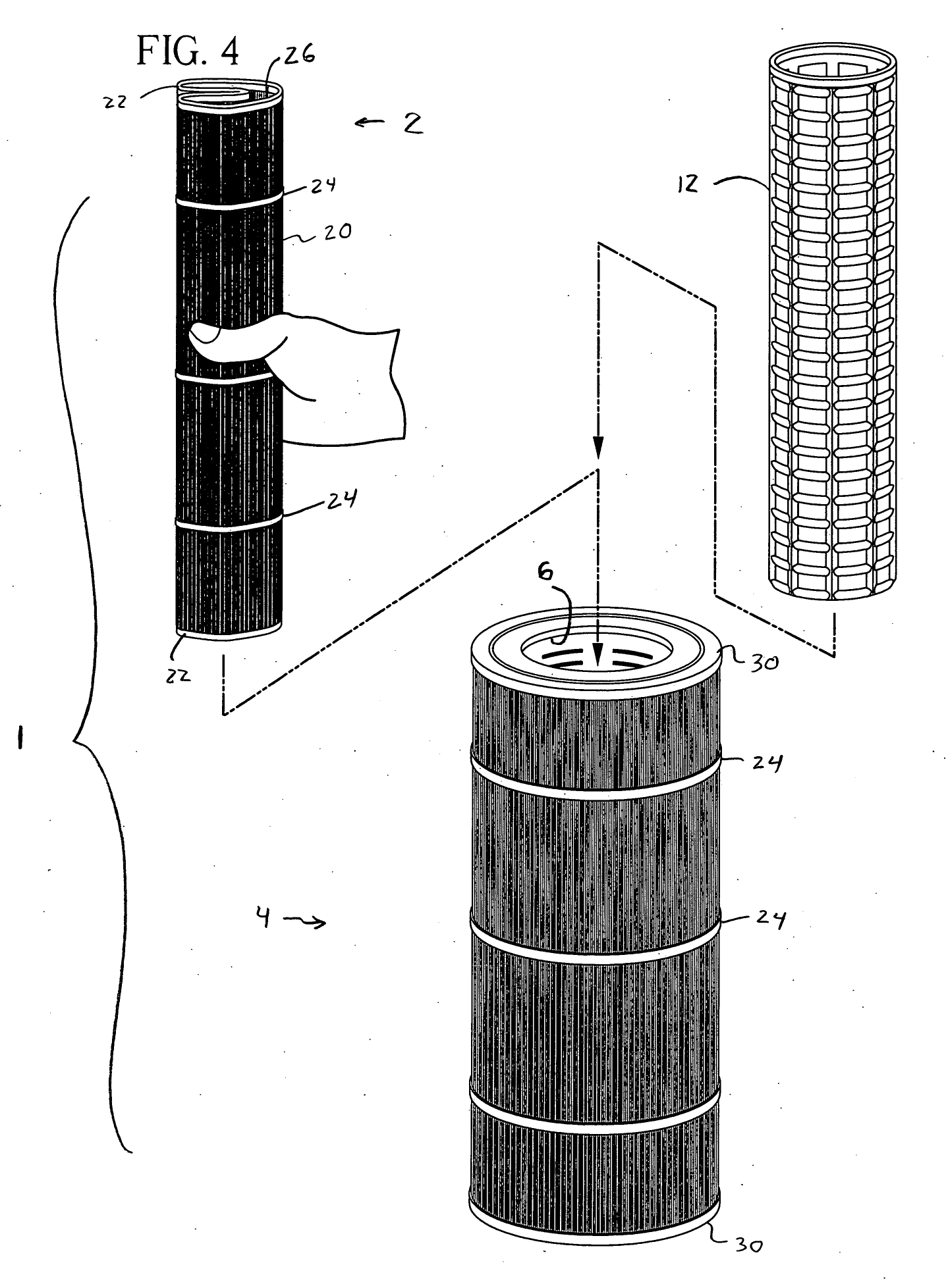

Referring initially to FIGS. 1-7, a two-stage, tandem filter cartridge assembly constructed in accordance with a first form of the present invention will now be described in detail. With this first form of the present invention, there are basically two embodiments shown, the first being illustrated by FIGS. 1-3 of the drawings, and the second being illustrated by FIGS. 4-7 of the drawings. Each embodiment includes a collapsible antimicrobial filter cartridge insert 2, which is received within an outer main filter element 4 of a filter cartridge assembly.

More specifically, the collapsible antimicrobial filter cartridge insert 2 of the present invention is intended to add some antimicrobial properties to the outer main filter element 10 of a filter cartridge 4 and to provide antimicrobial protection to the filter housing environment. It is not intended to provide any antimicrobial activity to the general pool or spa water environment; hence, no or limited FDA approval is required for use and sale of this product. The antimicrobial filter cartridge insert 2 is collapsible so that it can be easily inserted inside the standard cylindrical central bore 6 of either a pool or spa filter cartridge. It is expandable to a generally cylindrical shape so that in normal applications, it rests up against the inner surface of the main filter cartridge's core 8 or filter medium 10. A removable core 12 is then preferably inserted to give radially support to the antimicrobial filter element insert 2. This invention can be used as a collapsible antimicrobial filter insert in conjunction with the replacement filter cartridge assembly having a reusable core disclosed in the aforementioned Kott, et al. patent (U.S. Pat. No. 5,211,846).

With respect to the embodiment illustrated by FIGS. 1-3, the two-stage, tandem filter cartridge assembly of the present invention includes a core assembly that has a central core 12, a threaded nipple 14 which is affixed to one axial end of the core 12, and a female threaded collar 16 which affixed to the other end of the core. The core assembly is threaded onto a spa filter fitting, and then the collapsible antimicrobial filter element insert 2 is folded to a radially compressed state, inserted into the bore of the main (outer) filter cartridge 4, and allowed to expand within the bore 6 to its natural, generally cylindrical state. Then, the tandem assembly is slipped onto the core 12, and sealed at the top by threading an “H” shaped handle plug 18 with male threads into the female threads found at the top end collar 16 of the core assembly.

The collapsible antimicrobial insert element 2 can be removed by unscrewing the “H” handle plug 18, and removing both the outer filter 10 and the antimicrobial insert 2 at the same time. Then, by collapsing the insert 2 such as by folding it radially inwardly, one can remove the antimicrobial insert from the outer filter element 10. It should be noted that the collapsible antimicrobial insert 2 should be replaced more often than the main filter element 10, and the collapsibility of the antimicrobial insert facilitates its removal from the outer filter cartridge 4.

The collapsible antimicrobial filter cartridge insert 2 of the present invention is preferably formed of the following components:

1) an antimicrobial filter medium 20, for example, that which is commonly referred to as REEMAY® ADVANTAGE® manufactured by BBA FIBERWEB™ of Nashville, Tenn. The REEMAY® ADVANTAGE® media is essentially a 3 ounce REEMAY® filter media, style no. 2033, made of spun bonded 100% polyester that is treated with MICROBAN® antimicrobial agents. A different weight filter media, such as 4 ounce, may also be used. The filter media is pleated to a depth of preferably between about 0.200 inches and about 0.300 inches. Other antimicrobial filter media include, but are not limited to, antimicrobial AQUA SURE™ 3 (three ounce weight per square yard) and AQUA SURE™ 4 (four ounce weight per square yard) polyester substrates treated with zeolite, a copper/silver ion exchange resin manufactured by Hollingsworth and Vose Company of East Walpole, Mass., and that which is sold under the trademark REEMAY® LIBERTY®, a polypropylene blended filter medium treated with the antimicrobial agent MICROBAN®, a trademarked product of Microban International, Ltd. of New York, N.Y.

2) a pair of flexible elastomer end caps 22 preferably in the form of centrally open rings, each ring being affixed to one respective axial end of the filter medium 20 to help secure the medium in a generally cylindrical shape. The end caps 22 are preferably formed of a soft Shore A durometer polyurethane product, having a preferred durometer range of about Shore A 65 to about Shore A 90. Preferably, the end caps 22 have a wall thickness of between about 0.200 inches and about 0.300 inches; and

3) one or more axially spaced apart pleat bands 24 preferably made from a polyester material which are affixed to the outer circumferential surface of the pleated filter medium element 20 by gluing, such pleat bands 24 being disclosed in the aforementioned Kott, et al. patent (U.S. Pat. No. 5,211,846).

The particular pleat depth described above is preferred, as it enhances the collapsibility of the cartridge insert 2 and it allows the insert to be fitted within a standard outer filter cartridge 4 having a 4 inch inner diameter, and to receive a standard 3 inch reusable core 12 having an actual outer diameter of 3.45 inches without causing any interference with the core and the outer filter cartridge. The pleat bands 24 are preferably used to maintain the integrity of the insert 2 when it is in a collapsed state. The antimicrobial filter medium 20 described above is preferred, as it functions to remove the odor created by the presence of microbes formed in the primary cartridge filter 4 or its environs and interstices where contaminants are found or reside.

The particular specifications of the insert 2 set forth above allow for both collapsibility and expandability necessary for both the design and use of the insert.

FIG. 1 is an exploded perspective view of one form of a two-stage, tandem, replacement filter cartridge assembly 1 having a primary filter cartridge 4 and the collapsible antimicrobial filter cartridge insert 2 of the present invention. The insert 2 may be collapsed so that it may be received within the bore 6 of the outer or primary filter cartridge 4. Once inside the bore, the insert 2 is released so that it may expand to its full diameter. The reusable core 12 is then received by the inner bore 26 of the insert. A handle 8, such as the “H” shaped handle shown, having a threaded portion, is threaded onto the top axial end of the reusable core 12, having a threaded collar 16 formed with mating threads on its inner surface. The lower axial end of the core 12 includes a threaded portion 28 which mates with a threaded nipple 14 to affix the entire filter cartridge assembly 1 to the spa or pool filter unit.

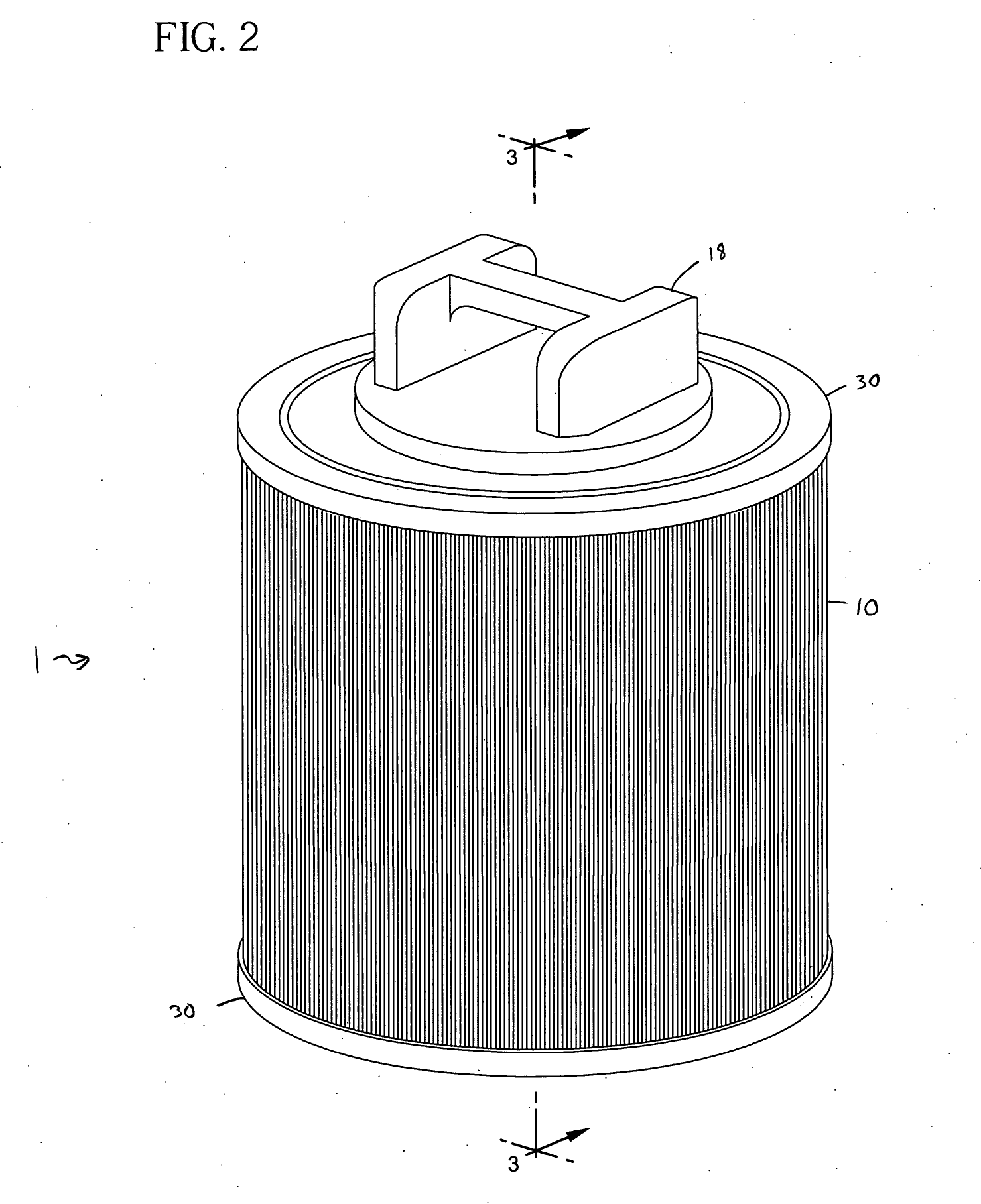

FIG. 2 is a perspective view of the unit 1 shown in FIG. 1 in its assembled state. It should be noted that the collapsible antimicrobial filter cartridge insert 2 is held captive within the overall filter cartridge assembly.

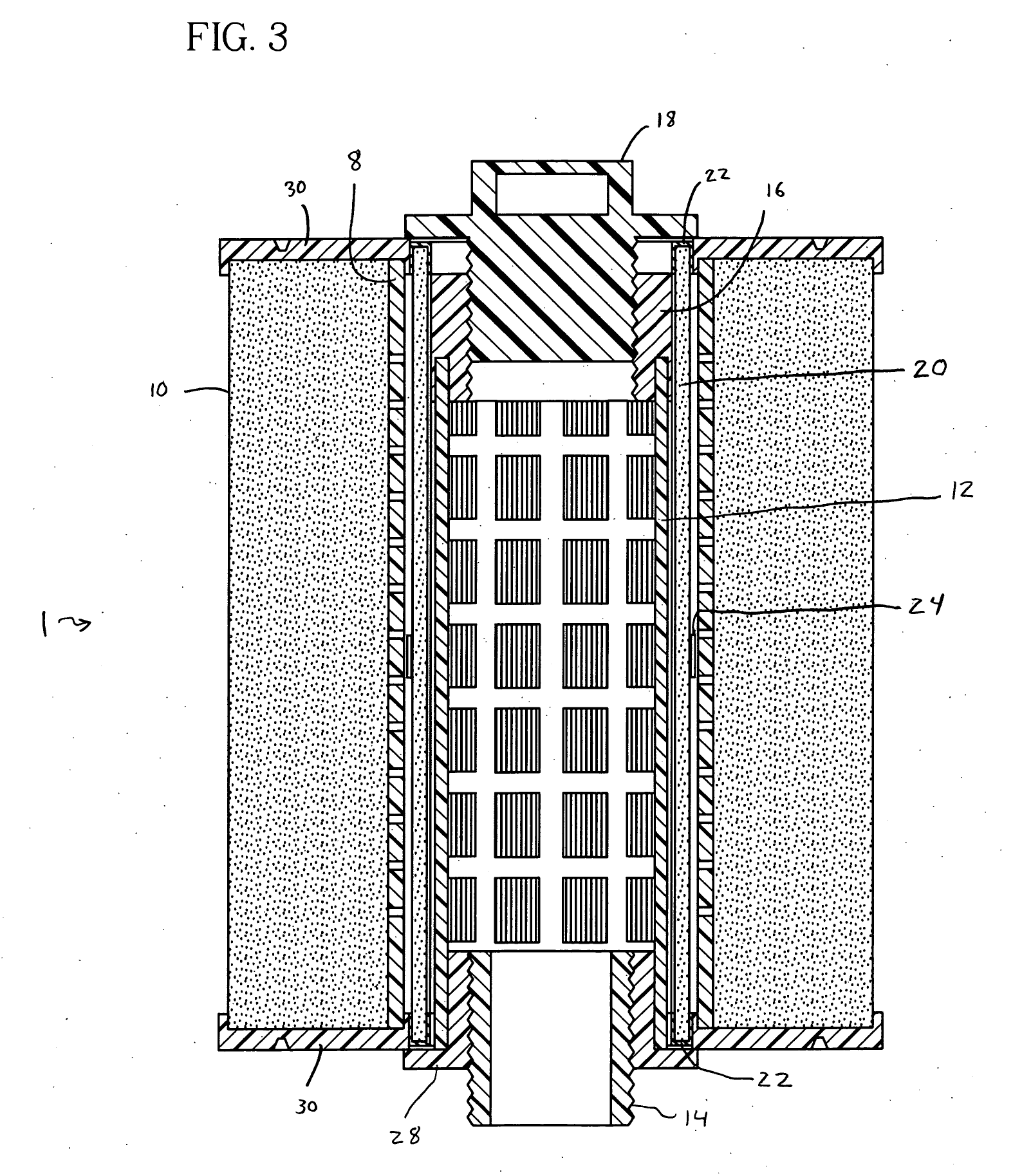

FIG. 3 is a cross-sectional view of the cartridge assembly 1 shown in FIG. 2, taken along line 3-3 of FIG. 2. The collapsible antimicrobial filter cartridge insert 2 can clearly be seen in its expanded state in FIG. 3.

It should further be noted that the entire filter cartridge 1 may be assembled by first slipping the collapsible antimicrobial filter cartridge insert 2 onto the reusable core 12, and then inserting the core 12 and insert 2 into the bore 6 of the outer or primary filter cartridge 4.

Another form of a two-stage, tandem, replacement filter cartridge assembly 1, having an outer or primary filter cartridge 4 and the collapsible antimicrobial filter cartridge insert 2 of the present invention, is shown. As with the other previously described filter cartridge assembly shown in FIGS. 1-3, the insert 2 of the present invention may be collapsed, as shown in FIG. 4, so that it may be received within the bore 6 of the outer or primary filter cartridge 4. Once inside the bore, the insert 2 is released so that it may expand to its full diameter. The reusable core 12 is then inserted into, and received by, the inner bore 26 of the insert 2.

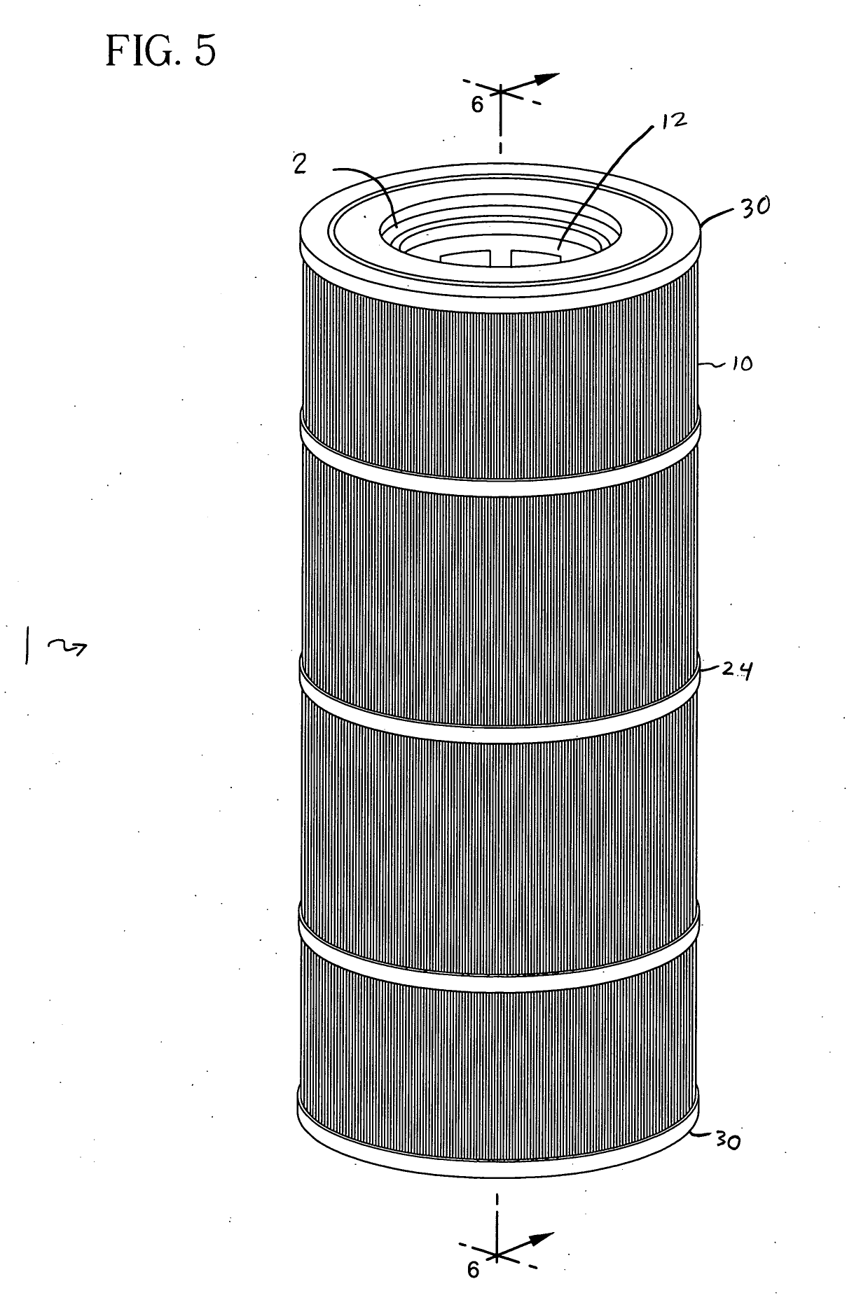

FIG. 5 is a perspective view of the unit 1 shown in FIG. 4 in its assembled state.

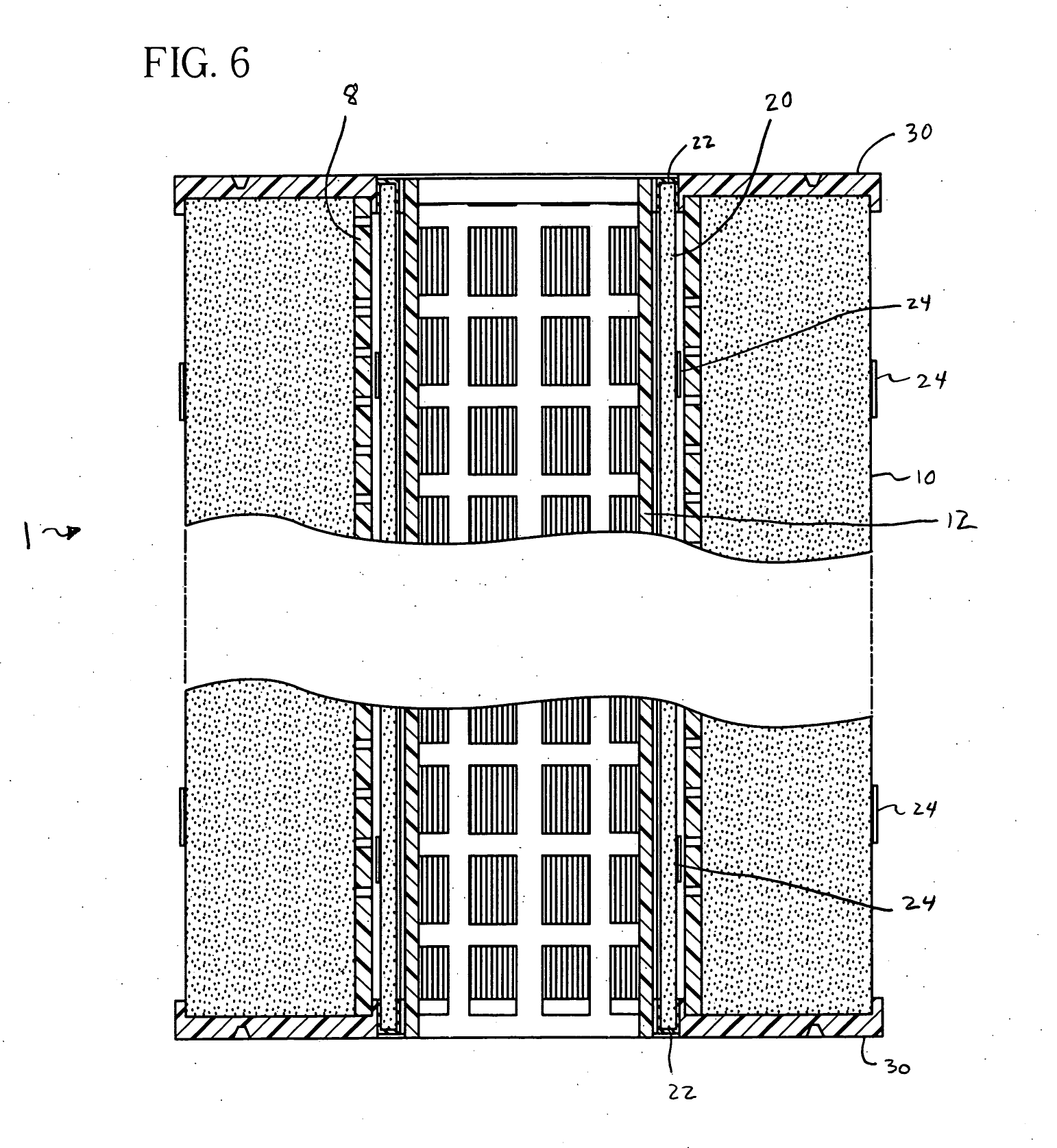

FIG. 6 is a cross-sectional view of the cartridge assembly 1 shown in FIG. 5, taken along line 6-6 of FIG. 5. The collapsible antimicrobial filter cartridge insert 2 can be clearly seen in its expanded state in FIG. 6.

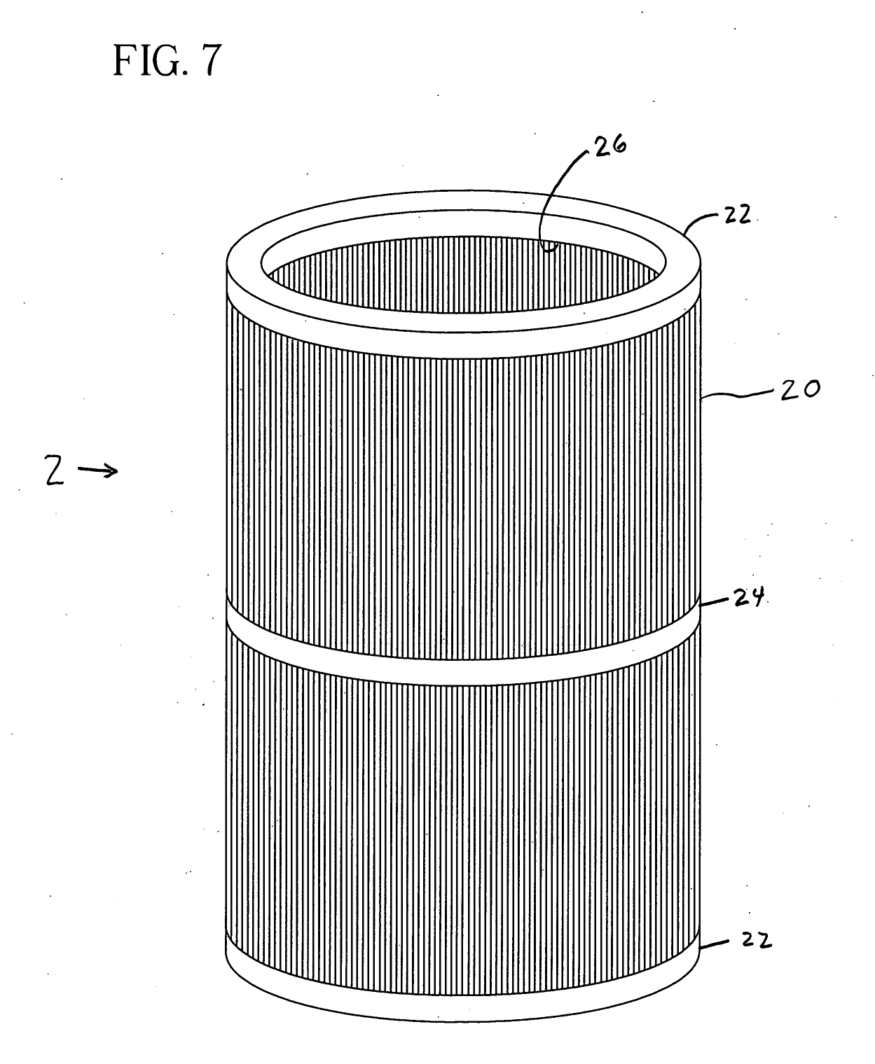

FIG. 7 is a perspective view of the collapsible antimicrobial filter cartridge insert 2 of the present invention, and shows the insert with the end caps 22 in the form of rings, the filter medium 20 and the pleat band or bands 24.

The pleated filter medium 10 of the outer or primary filter cartridge 4 may be a material formed from a spun bonded 100% polyester. For example, spun bonded polyester commercially available under the trademark REEMAY®, manufactured by BBA FIBERWEB™ of Nashville, Tenn., may be used. Also, although the particular embodiments of the two-stage, tandem, replaceable filter cartridge assembly 1 of the present invention includes a primary or outer filter cartridge 4 having a filter medium 10 formed from spun bonded polyester to remove dirt and other impurities, while the collapsible inner filter cartridge insert 2 is formed with a filter medium 20 having antimicrobial properties, it is envisioned to be within the scope of the present invention to form both the outer or primary filter cartridge 4 and the inner collapsible filter cartridge 2 from materials that exhibit antimicrobial properties. For example, the inner collapsible antimicrobial filter cartridge insert 2 may be formed from a material as previously described, which effectively acts as a zone inhibitor, while the outer or primary filter cartridge 4 may be formed from a material exhibiting different antimicrobial properties than that of the inner, collapsible filter cartridge. For example, the outer or primary filter cartridge medium 10 may be formed from an antimicrobial ionic exchange resin (e.g., copper and silver), such as commonly referred to by the trademark AQUA SURE™, which is a 100% polyester substrate coated with zeolite. Alternatively, both the outer or primary filter cartridge 4 and the collapsible inner filter insert 2 may be formed using the same or similar antimicrobial material. Also, each of the end caps of the primary or outer filter cartridge 4 and the inner collapsible filter cartridge 2 may be formed from a material exhibiting antimicrobial properties.

The opposite axial end caps 30 of the outer or primary filter cartridge 4 is preferably formed from polyurethane, and the outer tubular core 8 and the inner tubular core 12, which is preferably reusable, may be formed from a polypropylene, polyvinylchloride (PVC), acrylonitrile-butadiene-styrene (ABS) plastic or the like. The construction and structure of the outer or primary filter cartridge 4 is disclosed in detail in the aforementioned Kott, et al. patent (U.S. Pat. No. 5,211,846), the disclosure of which is incorporated therein by reference. The outer or primary filter cartridge 4, or both the outer filter cartridge and the inner, collapsible filter cartridge insert 2, may include bands 24 mounted circumferentially about the filter media 10, 20. The bands 24 may be formed from a bonded 100% polyester such as that sold under the trademark REEMAY®, or the like. The bands 24 are preferably attached to the filter medium 10, 20 by gluing the bands around the circumference of the filter medium. The bands 24 assist in maintaining the cylindrical shape of the filter medium 10, 20, and help to maintain separation between the pleats of the pleated filter medium.

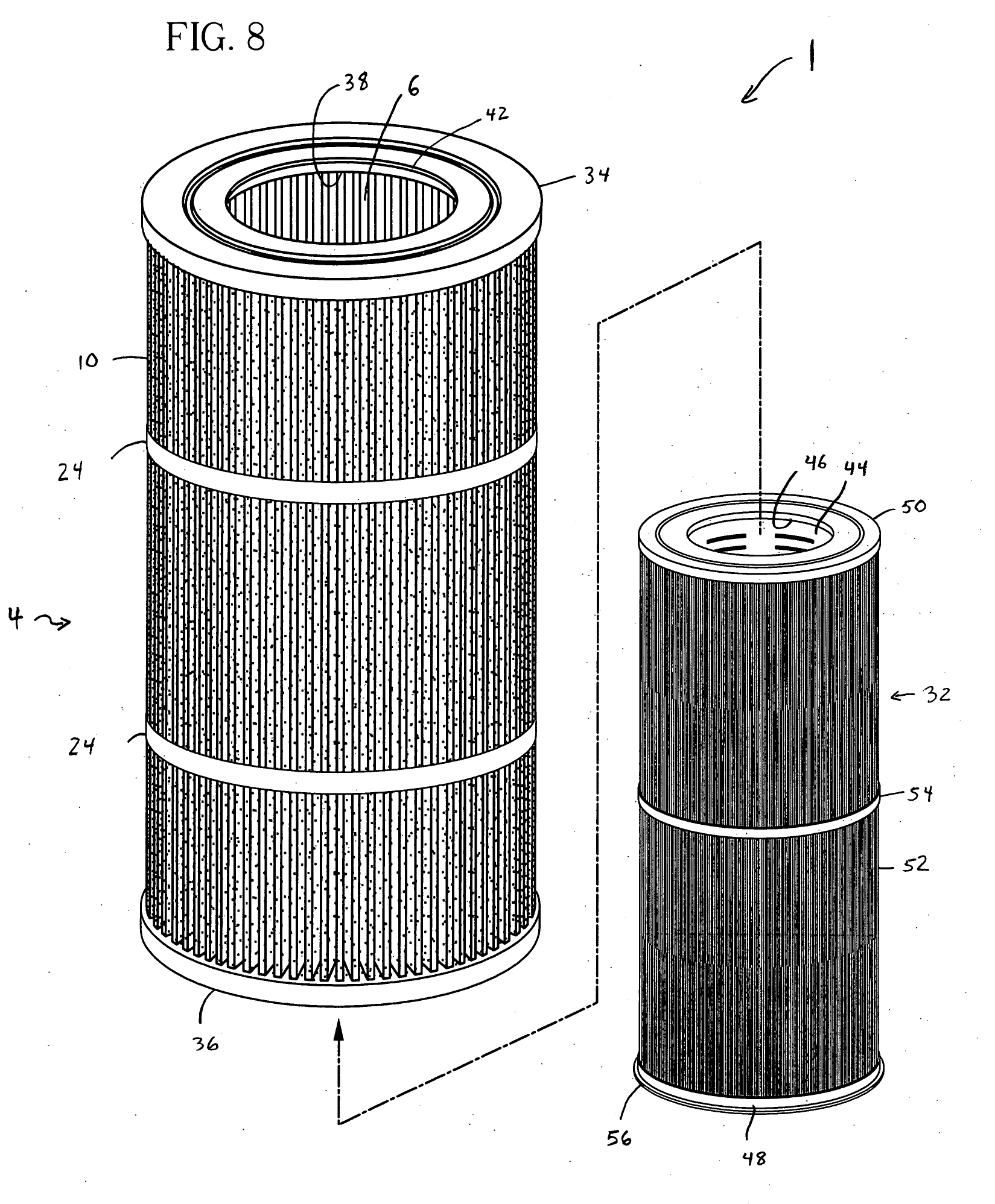

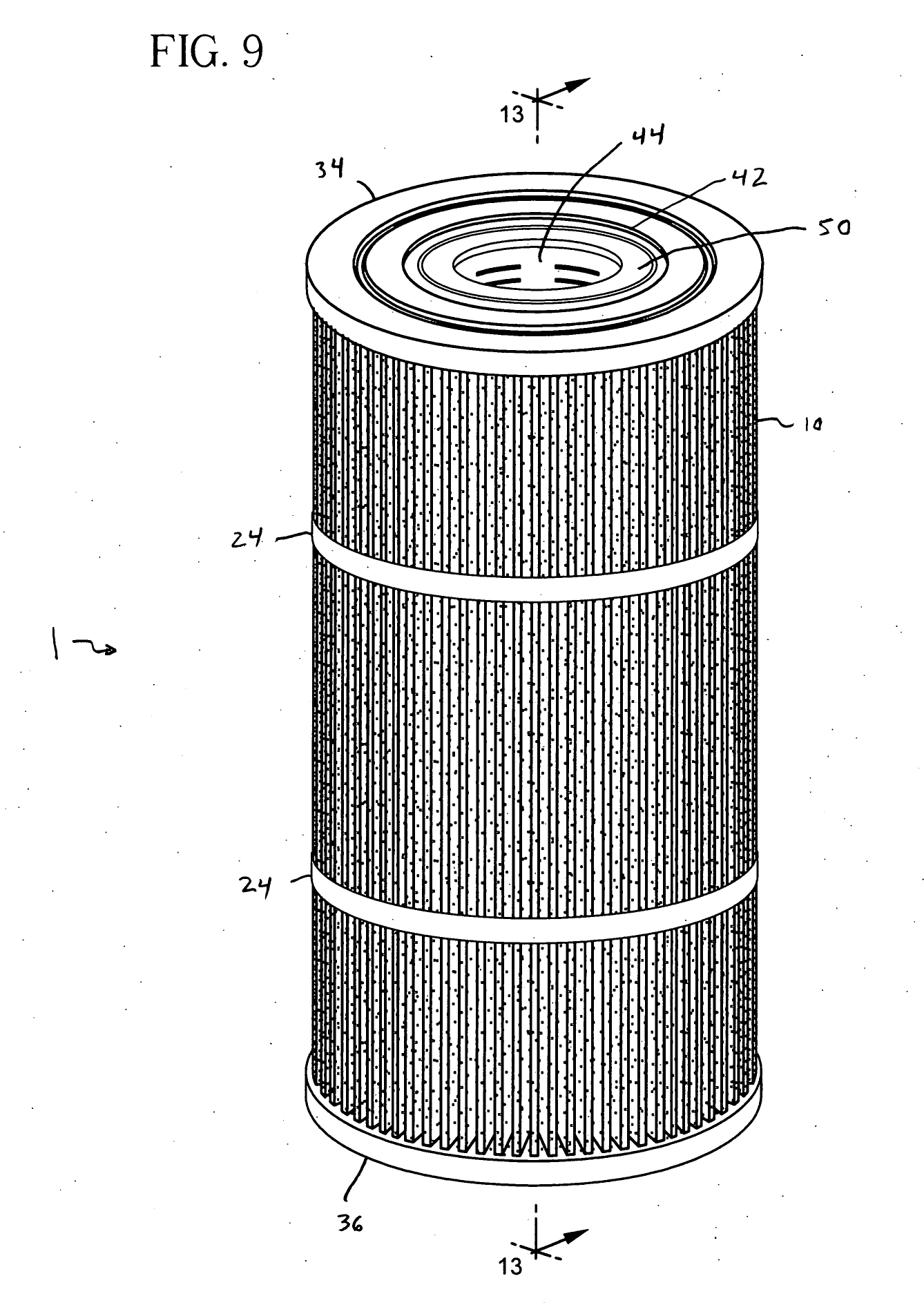

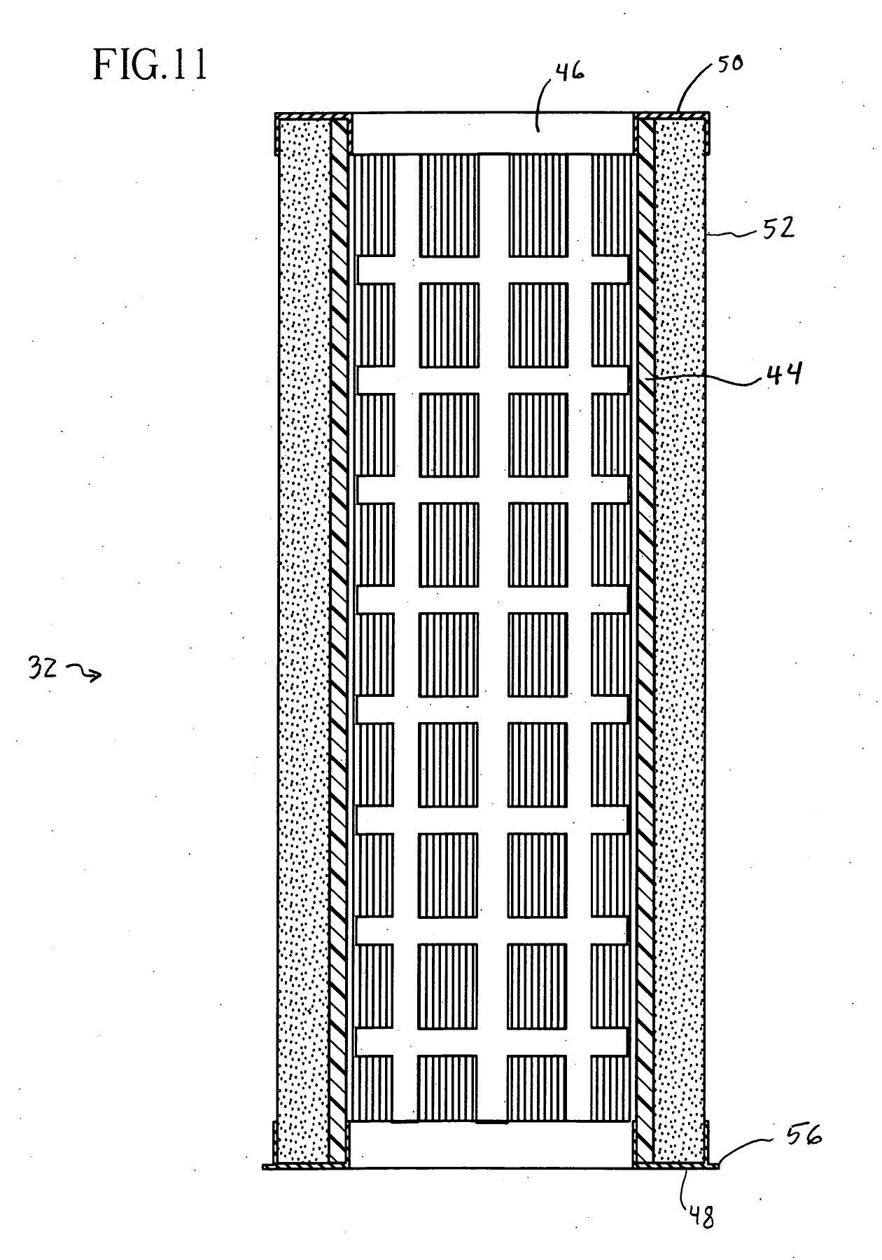

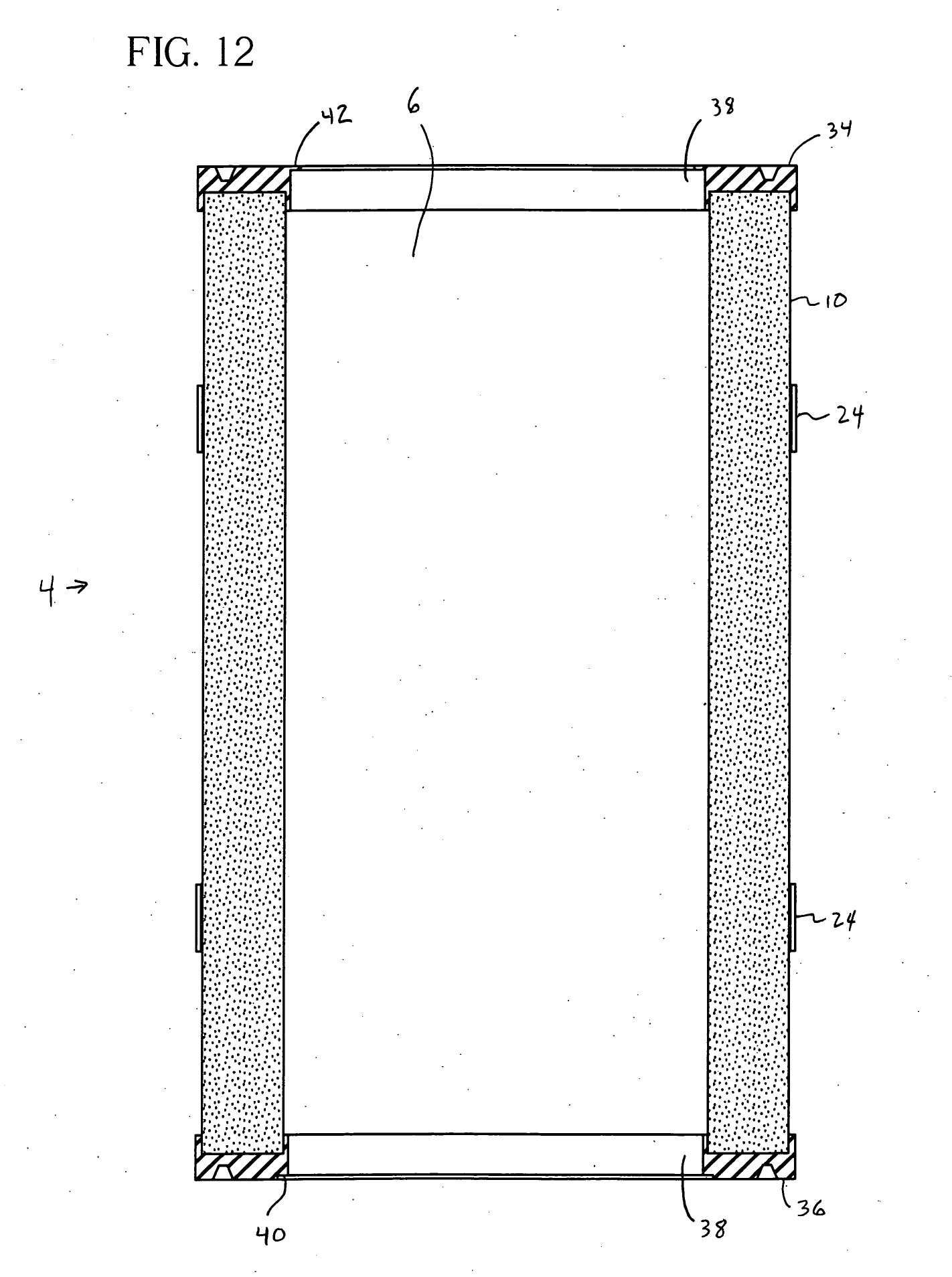

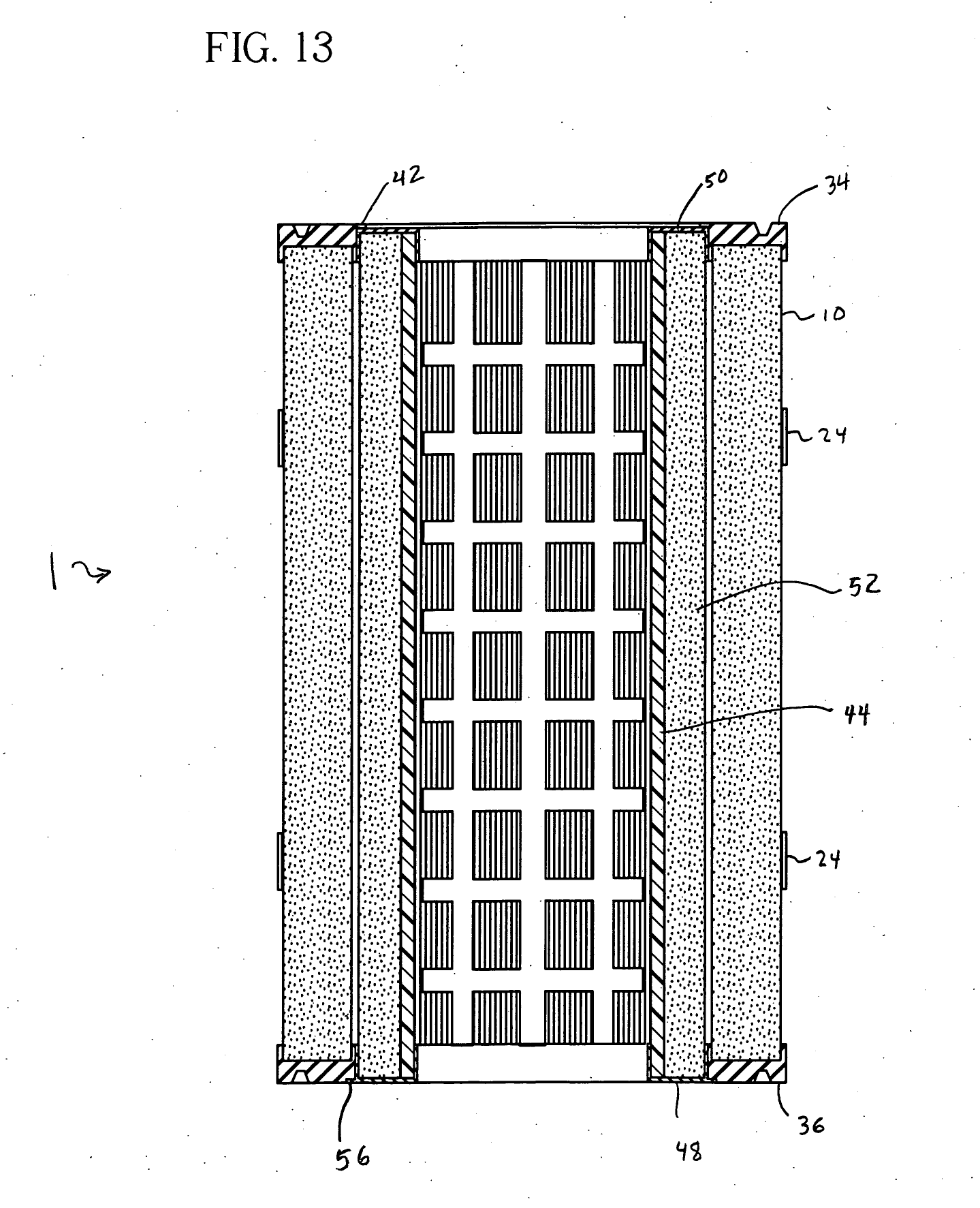

Another form of a two-stage, tandem replacement filter cartridge assembly 1 constructed in accordance with the present invention is shown in FIGS. 8-13 of the drawings. The two-stage, tandem, replaceable filter cartridge assembly 1 of this embodiment includes an outer filter cartridge 4 defining an interior, axially extending bore 6, and an inner filter cartridge 32 which is received by the axial bore 6 of the outer filter cartridge 4. The outer filter cartridge 4 includes a top end cap 34 and a bottom end cap 36, each of which is formed with a central opening 38 through the thickness thereof, which openings 38 communicate with the axial bore 6 of the filter cartridge 4. Each end cap 34, 36 is preferably formed from a soft polyurethane having a preferred durometer range of about Shore A 65 to about Shore A 90. The filter cartridge 4 also includes a pleated filter medium 10 which is cylindrically shaped to define the axial bore 6 of the outer filter cartridge 4. The axial ends of the pleated filter medium 10 engage and preferably adhere to the axial inside surfaces of the top and bottom end caps 34, 36. One or more bands 24 may circumferentially surround the pleated filter medium 10 to maintain the integrity of the filter cartridge 4, as disclosed in the aforementioned Kott, et al. patent.

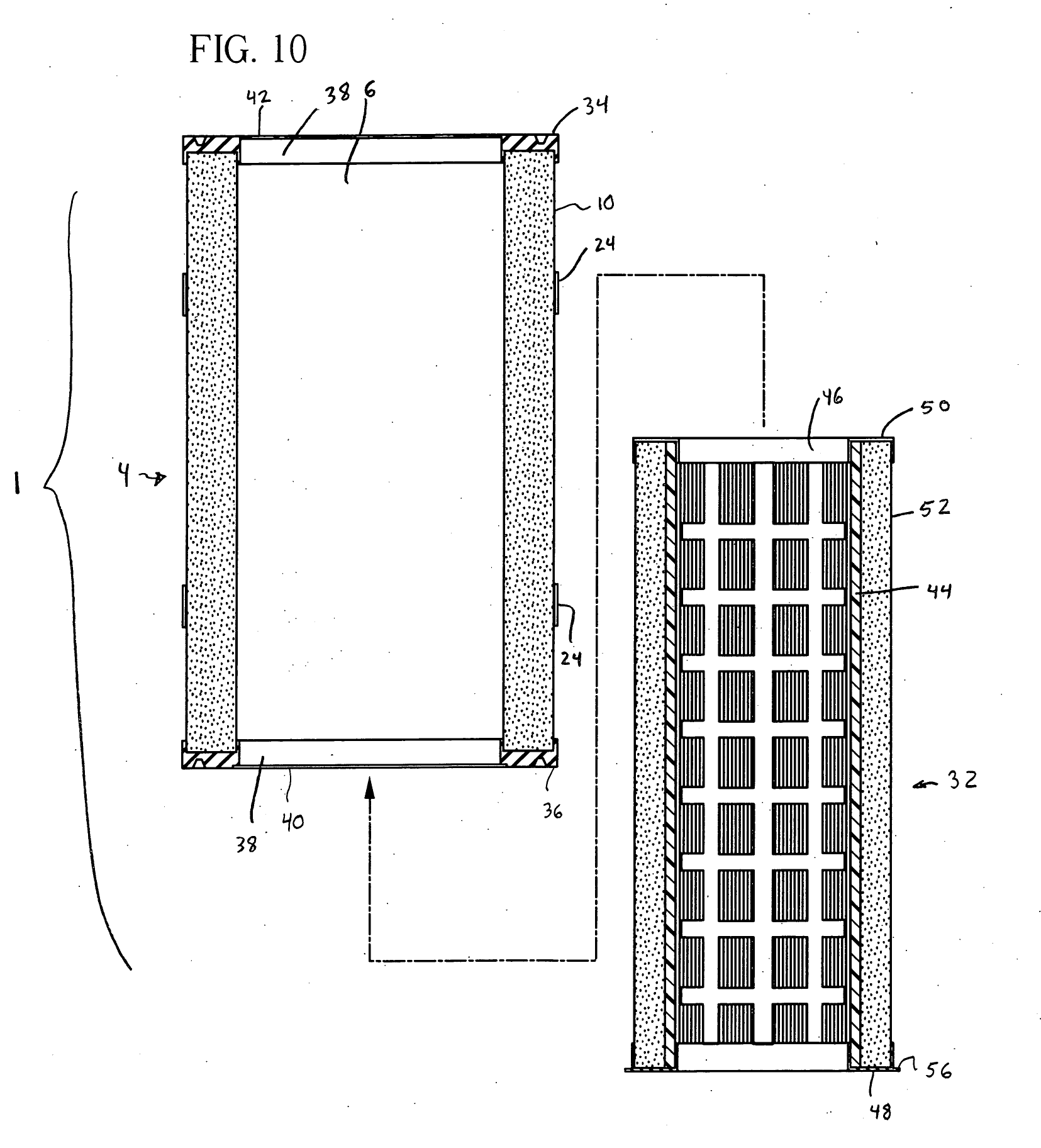

As can be more clearly seen in FIGS. 10, 12 and 13 of the drawings, the bottom end cap 36 of the outer filter cartridge 4 has a recess 40 formed in its outer surface along the inner periphery of the end cap and surrounding the central opening 38 formed therein. The top end cap 34 of the outer filter cartridge 2 includes a flange 42 extending radially inwardly from the outer surface of the top end cap about the inner periphery of the end cap surrounding the central opening 38 formed therein. As will be seen, the recess 40 formed in the bottom end cap 36 of the outer filter cartridge 4 and the flange 42 formed on the top end cap 34 are provided to help seal any spaces between the corresponding end caps 34, 36 of the outer and inner filter cartridges 4, 32 when the inner cartridge is received by the outer cartridge.

The inner filter cartridge 32 is cylindrically shaped like the outer filter cartridge 2. The inner filter cartridge 32 includes a perforated tubular core 44 having an axial bore 46 formed therethrough. The tubular core 44 may be formed from polypropylene, polyvinylchloride (PVC), acrylonitrile-butadiene-styrene (ABS) plastic or other material.

The inner filter cartridge 32 includes a bottom end cap 48 and a top end cap 50 disposed axially opposite the bottom end cap 48. The tubular core 44 axially extends between the top end cap 50 and the bottom end cap 48 and is preferably bonded to the inner surfaces of each end cap. A pleated filter medium 52 extends circumferentially about the core 44 between the top and bottom end caps 50, 48, and is also preferably adhered or bonded to the top and bottom end caps. The end caps 48, 50 of the inner filter cartridge 32 are preferably formed from a hard polyurethane having a preferred durometer range of about Shore D 70 to about Shore D 74.

The inner filter cartridge 32 may include one or more bands 54 mounted circumferentially about the filter medium 52. The bands 54 may be formed from a bonded 100% polyester, such as that sold under the trademark REEMAY®, or the like. Preferably, the bands 54 are attached to the filter medium 52 by gluing the bands around the circumference of the filter medium. The bands 54 assist in maintaining the cylindrical shape of the filter medium 52, and help maintain separation between the pleats thereof.

The filter medium 52 of the inner filter cartridge 32 is preferably formed from a spun bonded 100% polyester commercially available under the trademark REEMAY®, although it is envisioned that other materials may be used to form the filter medium. The primary purpose of the inner filter cartridge 32, when its filter medium 52 is formed from a spun bonded 100% polyester having no antimicrobial additives, is to remove dirt and other impurities from the water being filtered. However, and as will be explained in greater detail, the filter medium 52 of the inner filter cartridge 32 may also be formed from an antimicrobial material. Alternatively, both the filter medium 52 of the inner filter cartridge 32 and the filter medium 10 of the outer filter cartridge 4 may have no antimicrobial properties, and may be formed with the same or different micron retention rates, in order to provide two-stage filtering of dirt and impurities of the water passing therethrough.

As more specifically shown in FIGS. 10, 11 and 13 of the drawings, the bottom end cap 48 of the inner filter cartridge 32 includes a lip 56 which extends radially outwardly from the sidewall of the bottom end cap 48 at the lower surface thereof. The lip 56 extends a distance from the sidewall which is equal to or slightly less than the radial extent of the recess 40 formed in the bottom end cap 36 of the outer filter cartridge 4 so that, when the inner filter cartridge 32 is slideably received by the axial bore 6 of the outer filter cartridge 4, the lip 56 of the bottom end cap 48 of the inner filter cartridge 32 may be received by and seated in the recess 40 formed in the bottom end cap 36 of the outer filter cartridge 4.

As is shown in FIGS. 8, 10 and 13, the inner filter cartridge 32 is received by the axial bore 6 of the outer filter cartridge 4 by passing the top end cap 50 of the inner filter cartridge through the central opening 38 formed in the bottom end cap 36 of the outer filter cartridge 4. Insertion of the inner filter cartridge 32 within the outer filter cartridge 4 is continued until the lip 56 formed on the bottom end cap 48 of the inner filter cartridge 32 is seated in the recess 40 formed in the bottom end cap 36 of the outer filter cartridge 4, and the outer surface of the top end cap 50 of the inner filter cartridge 32 engages the axially inward surface of the flange 42 formed on the top end cap 34 of the outer filter cartridge 4.

Under normal operating conditions in either pressurized or vacuum skim filter cartridge systems, the two-stage, tandem replaceable filter cartridge assembly 1 of the present invention is subjected to substantial lateral and longitudinal pressures. These pressures are created by the flow of dirty water through the filter media of the inner and outer filter cartridges 32, 4 and the filtered clean water moving downwardly and exiting the filter housing (in which the filter cartridge assembly of the present invention resides) and returning to the pool, spa, whirlpool-type tub and the like. Because of the high water pressure that exists, it is possible that, without the structure of the top and bottom end caps of the inner and outer filter cartridges 32, 4 as described herein, unfiltered water may leak between the end caps of the inner and outer filter cartridges. This is especially so in a spa or whirlpool-type environment, where the heated water softens and expands to some degree the end caps 34, 36, 48, 50 of the inner and outer filter cartridges.

The engagement of the lip 56 of the bottom end cap 48 of the inner filter cartridge 32 with the recessed edge 40 of the bottom end cap 36 of the outer filter cartridge 4 defines a seal thereat to prevent or minimize the egress of water between the aligned bottom end caps 48, 36 of the inner and outer filter cartridges 32, 4. Similarly, the engagement of the outer surface of the top end cap 50 of the inner filter cartridge 32 with the axially inner surface of the flange 42 of the top end cap 34 of the outer filter cartridge 4 creates a seal thereat to prevent or minimize water leakage between the aligned top end caps of the outer and inner filter cartridges. Accordingly, the water being filtered cannot escape between the outer and inner filter cartridges 4, 32 and must pass through each filter medium 52, 10 of the inner and outer cartridges to provide a two-stage filtering of the water.

It is envisioned to be within the scope of the present invention to first seat the inner filter cartridge 32 on the suction component (not shown) of the filter apparatus, slip the outer filter cartridge 4 over the top of the inner filter cartridge, and then push down on the outer filter cartridge 4 to firmly seat it on the inner filter cartridge 32. Alternatively, the inner and outer filter cartridges 32, 4 may be assembled outside the filter apparatus and together the assembly may then be placed into the filter apparatus.

As mentioned previously, with respect to the two-stage, tandem replacement filter cartridge assembly 1 of the present invention shown in FIGS. 8-13 of the drawings, it is preferred that the outer filter cartridge 4 is formed with a pleated filter medium 10 having antimicrobial properties, such as the materials described previously with respect to the embodiment of the invention shown in FIGS. 1-7. Also, the top and bottom end caps 34, 36 of the outer filter cartridge 4 may be formed from a material also having antimicrobial properties. Like the first embodiment described previously and shown in FIGS. 1-7, the antimicrobial filter medium 10, and optionally the top and bottom end caps 34, 36 of the outer filter cartridge 4 of the embodiment of the invention shown in FIGS. 8-13, function to remove the odor created by the presence of microbes in the filter unit. The outer filter cartridge 4, with its antimicrobial properties, is not intended to provide any antimicrobial activity to the general pool or spa water environment and, therefore, no or limited FDA approval is necessary.

However, it should be realized that both filter media 52, 10 of the inner and outer filter cartridges 32, 4 of the two-stage, tandem replaceable filter cartridge assembly 1 of the present invention may be formed from an antimicrobial material, as well as each of the top and bottom end caps 34, 36, 48, 50. For example, the inner filter cartridge 32 may have its filter medium 52 formed from an ionic exchange resin, such as the material referred to by the trademark AQUA SURE™, a 100% polyester substrate with zeolite, while the outer filter cartridge 4 may have its filter medium 10 formed from a zone inhibiting antimicrobial material, such as the aforementioned material referred to by the trademark MICROBAN®. Alternatively, the filter medium 52 of the inner filter cartridge 32 may be formed from a zone inhibiting antimicrobial material, while the filter medium 10 of the outer filter cartridge 4 may be formed from an ionic exchange resin.

As mentioned previously, the end caps 34, 36 of the outer filter cartridge 4, and/or the end caps 48, 50 of the inner filter cartridge 32, may include an antimicrobial agent, such as that referred to earlier by the trademark MICROBAN®. More specifically, the polyurethane used in molding the end caps is a two-part system, consisting of a first component (the base), also commonly referred to as the polyol side, to which the MICROBAN® agent is added, and a catalyst side, which is an isocyanate pre-polymer adduct.

As it can be seen from the foregoing description, the two-stage, tandem, replaceable filter cartridge assembly 1 of the present invention provides enhanced filtering of the water passing therethrough. The filter cartridge assembly of the present invention not only filters the water to remove dirt and other impurities, but also removes odor caused by microbes residing in the filter unit in which the filter cartridge assembly is situated. Furthermore, the inner and outer filter cartridges 32, 4 of the assembly may be separately replaced, as the antimicrobial filter cartridge need not be replaced as frequently as the other filter cartridge of the assembly having no antimicrobial additives.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A two-stage, tandem, replaceable filter cartridge assembly, which comprises:
an outer filter cartridge, the outer filter cartridge including a filter medium disposed in a cylindrical shape to define a first axial bore therein, a first end cap and a second end cap disposed axially opposite the first end cap, the filter medium being situated between the first end cap and the second end cap, each of the first end cap and the second end cap having a central opening formed through the thickness thereof which communicates with the first axial bore; and
an inner filter cartridge, the inner filter cartridge including a filter medium disposed in a cylindrical shape to define a second axial bore therein, a first end cap and a second end cap disposed axially opposite the first end cap, the filter medium of the inner filter cartridge being situated between the first end cap and the second end cap of the inner filter cartridge, each of the first end cap and the second end cap of the inner filter cartridge having a central opening formed through the thickness thereof which communicates with the second axial bore, the inner filter cartridge being receivable by and situatable in the first axial bore of the outer filter cartridge;
wherein the filter medium of at least one of the inner filter cartridge and the outer filter cartridge is made from an antimicrobial material.

2. A two-stage, tandem, replaceable filter cartridge assembly as defined by claim 1, wherein the inner filter cartridge is collapsible to a first state to facilitate insertion thereof into the first axial bore of the outer filter cartridge, and expandable to a second state when received by the first axial bore of the outer filter cartridge, the inner filter cartridge when in the second state being in the form of a generally cylindrical shape.

3. A two-stage, tandem, replaceable filter cartridge assembly as defined by claim 2, wherein the outer diameter of the inner filter cartridge, when in the expanded second state, is greater than the inner diameter of the first axial bore of the outer filter cartridge, and wherein the outer diameter of the second filter cartridge, when in the collapsed first state, is less than the inner diameter of the first axial bore of the outer filter cartridge.

4. A two-stage, tandem, replaceable filter cartridge assembly as defined by claim 1, wherein the filter medium of at least one of the inner filter cartridge and outer filter cartridge that is made form an antimicrobial material is at least partially made from an ionic exchange resin.

5. A two-stage, tandem, replaceable filter cartridge assembly as defined by claim 1, wherein the filter medium of the at least one of the inner filter cartridge and the outer filter cartridge that is made from an antimicrobial material is at least partially made from a zone inhibiting material.

6. A two-stage, tandem, replaceable filter cartridge assembly as defined by claim 1, wherein the filter medium of the outer filter cartridge is made from a spun bonded polyester material, and wherein the filter medium of the inner filter cartridge is made from an antimicrobial material.

7. A two-stage, tandem, replaceable filter cartridge assembly as defined by claim 1, wherein the filter medium of the outer filter cartridge is made from an antimicrobial material, and wherein the filter medium of the inner filter cartridge is made from a spun bonded polyester material.

8. A two-stage, tandem, replaceable filter cartridge assembly as defined by claim 1, wherein the filter medium of the outer filter cartridge is made from a zone inhibiting antimicrobial material, and wherein the filter medium of the inner filter cartridge is made from an ionic exchange antimicrobial material.

9. A two-stage, tandem, replaceable filter cartridge assembly as defined by claim 1, wherein the filter medium of the outer filter cartridge is made from an ionic exchange antimicrobial material, and wherein the filter medium of the inner filter cartridge is made from a zone inhibiting antimicrobial material.

10. A two-stage, tandem, replaceable filter cartridge assembly as defined by claim 1, wherein the first end cap of the inner filter cartridge includes a lip extending radially outwardly therefrom and circumferentially thereabout; and wherein the first end cap of the outer filter cartridge includes an outer axial surface having a recessed portion formed therein about the central opening formed therethrough, the recessed portion defining a recess in which is at least partially received the lip of the first end cap of the inner filter cartridge when the inner filter cartridge is received by the first axial bore of the outer filter cartridge to provide a seal to minimize the passage of water between the first end cap of the outer filter cartridge and the first end cap of the inner filter cartridge.

11. A two-stage, tandem, replaceable filter cartridge assembly as defined by claim 10, wherein the second end cap of the inner filter cartridge includes an outer axial surface; and wherein the second end cap of the outer filter cartridge includes a flange extending radially inwardly of the central opening formed therein, at least a portion of the outer surface of the second end cap of the inner filter cartridge engaging the flange of the second end cap of the outer filter cartridge when the inner filter cartridge is received by the first axial bore of the outer filter cartridge to minimize the passage of water between the second end cap of the outer filter cartridge and the second end cap of the inner filter cartridge.

12. A two-stage, tandem, replaceable filter cartridge assembly as defined by claim 1, wherein the second end cap of the inner filter cartridge includes an outer axial surface; and wherein the second end cap of the outer filter cartridge includes a flange extending radially inwardly of the central opening formed therein, at least a portion of the outer surface of the second end cap of the inner filter cartridge engaging the flange of the second end cap of the outer filter cartridge when the inner filter cartridge is received by the first axial bore of the outer filter cartridge to minimize the passage of water between the second end cap of the outer filter cartridge and the second end cap of the inner filter cartridge.

13. A two-stage, tandem, replaceable filter cartridge assembly, which comprises:
an outer filter cartridge, the outer filter cartridge including a filter medium disposed in a cylindrical shape to define a first axial bore therein, a first end cap and a second end cap disposed axially opposite the first end cap, the filter medium being situated between the first end cap and the second end cap, each of the first end cap and the second end cap having a central opening formed through the thickness thereof which communicates with the first axial bore; and
an inner filter cartridge, the inner filter cartridge including a filter medium disposed in a cylindrical shape to define a second axial bore therein, a first end cap and a second end cap disposed axially opposite the first end cap, the filter medium of the inner filter cartridge being situated between the first end cap and the second end cap of the inner filter cartridge, each of the first end cap and the second end cap of the inner filter cartridge having a central opening formed through the thickness thereof which communicates with the second axial bore, the inner filter cartridge being receivable by and situatable in the first axial bore of the outer filter cartridge.
